(19) United States
(12) Patent Application Publication
(10) Pub. No.: US 2026/0346268 A1
(43) Pub. Date: Nov. 5, 2026

(54) SCREW HUB, CENTRIFUGAL SCREW, AND SOLID BOWL SCREW CENTRIFUGE

(71) Applicant: FLOTTWEG SE, Vilsbiburg (DE)

(72) Inventors: Daniel Schroft, Gerzen (DE); Michael Beywl, Bodenkirchen (DE); Michael Nettinger, Landshut (DE); Matthias Scheidhammer, Vilsbiburg (DE); Matthias Weber, Geisenhausen (DE); Michael Geltinger, Schalkham (DE)

(21) Appl. No.: 19/099,950

(22) PCT Filed: Aug. 3, 2023
(86) PCT No.: PCT/EP2023/071593

§ 371 Date: Jan. 30, 2025

(30) Foreign Application Priority Data
Aug. 3, 2022 (DE) 10 2022 119 469.8

(51) Int. Cl. B04B 1/20

(52) U.S. Cl. CPC B04B 1/20; B04B 2001/2041; B04B 2001/205

(57) ABSTRACT

The invention relates to a screw hub (20) for a centrifugal screw (10), comprising at least one monolithically formed hub section (30), in particular at least two interconnected monolithically formed hub sections (30), wherein the at least one hub section (30) has a circumferential wall (31) and two end faces (33, 34), and a plurality of openings (32) are formed in the circumferential wall (31), said hub section (30) having at least one transverse disc (40).

The invention relates to a screw hub for a centrifugal screw, comprising at least one monolithically formed hub section, in particular at least two interconnected monolithically formed hub sections, according to patent claim 1. The invention furthermore relates to a centrifugal screw with a screw hub according to the invention, according to patent claim 14. In addition, the invention relates to a solid bowl screw centrifuge according to patent claim 15.

Solid bowl screw centrifuges are characterized by a drum with closed or solid jacket, respectively. The drum is rotated at high speed, whereby a multi-phase mixture located in the drum can be separated into at least a heavy phase and a light phase. The heavy phase is generally a solid phase, which is guided out of the drum by means of a screw, i.e., a centrifugal screw. For this purpose, the screw is mounted in the drum so as to be rotatable relative to the drum and has a screw flight. The screw flight is directly or indirectly fastened to the screw hub and surrounds the latter spirally.

The screw flight slides along the inner side or inner jacket surface of the drum, respectively, and thus conveys the goods of the heavy phase to an axial end region of the drum. At the end of the drum, the goods of the heavy phase are, for example, conveyed out of a discharge cone. The multi-phase mixture to be clarified is thus located between the inner side of the drum and the screw hub.

In particular for sewage treatment technology-related reasons, a large pond depth is sought in certain solid bowl screw centrifuges. However, the pond depth is simultaneously limited due to the diameter of the screw hub and buoyancy and deposition effects of the mixture to be clarified or of the light phase, respectively, which result there.

On the other hand, it is the constant endeavor to form a screw hub with sufficient or increased stiffness, respectively.

The pond depth can be increased thereby in that the screw hub is formed to be particularly permeable for media, but this may weaken the structure of the screw hub.

The invention is thus based on the object of providing a screw hub for a centrifugal screw, which has an increased stiffness and simultaneously improved flow properties due to an improved structural design.

The invention is further based on the object of providing for a modular design of the screw hub, so that the size, in particular the longitudinal extension of the screw hub, can be formed in terms of a modular system.

The invention is further based on the object of specifying a screw hub and a solid bowl screw centrifuge.

According to the invention, this object with respect to the screw hub is solved by means of the subject matter of claim 1. With respect to the centrifugal screw, the above-mentioned object is solved by means of the subject matter of claim 14. With respect to the solid bowl screw centrifuge, the above-mentioned object is solved by means of the subject matter of claim 15. The subclaims comprise at least expedient configurations and further developments.

The object is solved concretely by means of a screw hub for a centrifugal screw, which comprises at least one monolithically formed hub section, in particular at least two interconnected monolithically formed hub sections. The screw hub extends along a longitudinal axis. This longitudinal axis also forms the longitudinal axis of the centrifugal screw or solid bowl screw centrifuge, respectively.

The at least one hub section has a circumferential wall and two front sides. A plurality of openings is formed in the circumferential wall, wherein the hub section, in particular the at least one hub section, has at least one transverse disk.

The screw hub according to the invention combines several advantages due to the novel design of at least one, preferably at least two, interconnected hub section(s). Due to the monolithic formation, the hub section has a particularly high stiffness. Due to the plurality of openings, a large pond depth can simultaneously be attained. Due to the fact that at least one transverse disk is part of the monolithically formed hub section, this simplifies the production of the hub section because the transverse disk does not have to be connected to the hub in a separate process but is already part of the screw hub.

In particular a hub section, which is formed in one piece and without joints, is to be understood as a monolithically formed hub section.

The longitudinal direction of a screw hub is essentially defined by the orientation of the longitudinal axis of a screw hub. The longitudinal axis of a screw hub is the axis, around which the screw hub rotates during use.

The longitudinal direction is preferably defined as the direction of the transport of the solid material discharge. In the longitudinal direction of the centrifugal screw, the latter can have at least two different sections. A first section is the cylindrical longitudinal section thereby. A further section, which follows in the longitudinal direction, is a solid material discharge-side section. This solid material discharge-side section can be formed, for example, in a conical or double-conical manner, or, compared to the cylindrical longitudinal section, in a tubular manner with smaller diameter.

The medium, which is to be processed or to be separated with the help of the centrifugal screw, can be a multi-phase medium. The medium can be, for example, a 2-phase mixture or a 3-phase mixture. It is also possible to use the screw hub according to the invention for a centrifugal screw for separating a 3-phase mixture, wherein a solid phase and two liquid phases are present.

The monolithically formed hub section is preferably one of several hub sections of a screw hub. In other words, the screw hub is preferably formed from several, i.e., from at least two interconnected hub sections. In a particularly preferred embodiment of the invention, the screw hub is formed by at least two monolithically formed hub sections, wherein both monolithically formed hub sections have the features according to the invention, i.e., that both hub sections preferably have a circumferential wall and at least two front sides, and a plurality of openings is formed in the circumferential wall, and each hub section furthermore has at least one transverse disk.

It is possible thereby that the at least two monolithically formed hub sections are formed differently with respect to their features according to the invention. This means that even though the at least two monolithically formed hub sections each have a transverse disk, they are arranged at different positions in relation to the longitudinal extension of the respective hub section. In addition, the at least two monolithically formed hub sections can differ from one another with respect to their openings (e.g., arrangement, number, shape).

In other words, it is possible that a screw hub is composed of or produced from several similarly formed hub sections, respectively. For this purpose, the similar monolithically formed hub sections are interconnected.

The hub sections can in particular be interconnected by means of a substance-to-substance bond and/or in a non-positive manner. With respect to a substance-to-substance bond, a welded connection is suitable in a special way. On the one hand, this provides for a stable connection of the hub sections. On the other hand, this is a comparatively simple method for connecting the hub sections, wherein a corresponding welding process can also be carried out in an automated manner.

In the case of the non-positive connection of the hub sections, in particular in the case of a screw connection, a hub section can be released easily and quickly and can thus be replaced, for example due to wear. A modular design of the screw hub, which can be realized easily, is further made possible by means of such a connection of the hub sections, so that the screw hub can be produced easily in different installation sizes or installation lengths, respectively.

In a particularly preferred embodiment of the invention, the plurality of openings in the circumferential wall is formed as part of the monolithic shape of the hub section. This means that the openings are not openings, which are subsequently introduced into a circumferential wall, but that the monolithic shape of the hub section already has these openings. In other words, the monolithically formed hub section is formed in such a way that due to the production process, the monolithically formed hub section already has its final shape. No further shaping post-processing steps, such as, e.g., milling-out processes, are thus necessary.

The openings of the circumferential wall can have different shapes or geometries, respectively. It is possible, for example, that the openings essentially have a triangular shape and/or square shape. It is possible in particular that the openings of a hub section vary both with respect to the size and the shape, i.e., are formed differently. This provides for the formation of a circumferential wall with optimal distribution of the openings, in particular with respect to the provision of a web-like wall section, which in particular runs spirally, which serves the purpose of fastening a screw flight.

The openings of the circumferential wall can be limited by means of strut-like and/or web-like elements. In other words, the geometry or the shape of the openings can be formed with the help of strut-like and/or web-like elements.

The web-like elements can, at least in sections, be the web-like wall section or a subsection of the web-like wall section, which serves the purpose of fastening a screw flight. An opening is preferably in each case formed from at least one subsection of a web-like wall section and at least two struts, wherein the struts are preferably defined as such wall sections, which only serve the purpose of limiting the opening and which do not form or have any additional wall sections for fastening a screw flight.

It is furthermore possible that an opening is formed from two subsections of one or several web-like wall section/wall sections and at least two struts.

In a preferred embodiment of the invention, the openings have a triangular shape, wherein two triangular openings are in each case arranged relative to one another in such a way that the two openings form a rhombus shape. In a particularly preferred embodiment of the invention, the hub section has several openings with a triangular shape, wherein together, two openings of this type each form a rhombus shape. The rhombuses, in turn, are arranged offset relative to one another in the hub section. In a particularly preferred embodiment of the invention, a web-like wall section (which serves the purpose of fastening a screw flight) runs through the junctions of the struts in this case. Such a formation of the hub section provides for a particularly stable and simultaneously light construction of the hub section.

The length of the monolithically formed hub section is preferably 0.5- to 3-times, in particular 1- to 2.5-times, in particular 1- to 2-times, the diameter of the hub section. A monolithically formed hub section can be provided with the help of such length/diameter ratios, with the help of which it is made possible that a screw hub can be formed from several, preferably similar or identical, monolithically formed hub sections.

In a possible embodiment of the invention, the at least one transverse disk is formed on a front side of the hub section. The front side of the hub section is one of the two end sides of the hub section, which close the circumferential wall in the longitudinal direction of the hub section.

The formation on a transverse disk on only one front side of the hub section has the advantage that material can be saved with respect to the formation of transverse disks. By connecting several hub sections, a transverse disks can in each case be formed between two hub sections, which are to be connected.

In a further embodiment of the invention, it is possible that a transverse disk is in each case formed on both front sides of the hub section. This, in turn, has the advantage that the hub sections formed in this way can be formed at each position of the screw hub, which is to be formed. This means that the hub section, which is monolithically formed in this way, can also form the end part of a cylindrical longitudinal section of a screw hub. This relates to a discharge-side end part of a cylindrical longitudinal section of a screw hub as well as to an input-side end part of a cylindrical longitudinal section of a screw hub.

In the case of a formation of a hub section with two transverse disks, it is possible to form the respective transverse disks with a relatively thin material thickness because a common transverse disk with correspondingly larger material thickness can be formed in response to a connection of two such monolithically formed hub sections, because at least two transverse disks preferably lie against each other.

In a further embodiment of the invention, the at least one transverse disk of at least one monolithically formed hub section can be formed in the longitudinal direction of the hub section at a position, which essentially corresponds to the lengthwise bisector of the length of the hub section. Such a position, which is formed centrally with respect to the length of the hub section, is to in particular be understood as a position, which essentially corresponds to the lengthwise bisector of the length of the hub section. For manufacturing reasons, this does not have to 100 % exactly match the lengthwise bisector of the length. Slight deviations, in particular deviations of +10 %, in particular of +5 %, are possible here.

In the case of the formation of several hub sections of this type, which comprise at least one transverse disk at a position, which essentially corresponds to the lengthwise bisector of the length of the hub section, in particular to the lengthwise bisector of the length of the hub section, it is possible that the front sides of the hub section do not mandatorily have to be formed in a plane, which is formed perpendicular to the longitudinal axis of the hub section. On the contrary, it is possible that the front sides can be formed obliquely or spirally or so as to overlap, compared to an adjacently arranged hub section. In the case of such an embodiment of the invention, two monolithically formed hub sections, which are to be connected, can also be interconnected by means of a connecting section, for example welded seam, which does not correspond to a round seam.

The shape of a hub section of this type with, for example, oblique ends corresponds to the shape of an obliquely cut-off circular cylinder. The bevel can thereby be formed on both end sides or front sides, respectively, of the hub section. The formation on only one side is also possible, provided that, for example, the respective hub section is formed or positioned as end-side section of the cylindrical longitudinal section of the screw hub.

It is possible that several monolithically formed hub sections, which form a screw hub, with overlapping and/or oblique and/or spiral front sides are arranged and formed in a complementary manner to one another in such a way that they are formed so as to engage with one another, so that a connection, which is particularly advantageous with respect to the stiffness, of hub sections, which are arranged adjacently or next to one another, respectively, can be realized.

It is possible that a screw hub is formed from several hub sections, which are formed differently with respect to the transverse disk arrangement. It is thus conceivable, for example, that the hub sections formed centrally with respect to the cylindrical longitudinal section are each formed with two transverse disks, which are each formed on a front side of each individual hub section. Hub sections arranged on the end side, in contrast, can be formed, for example, with only one transverse disk. It is possible hereby that the transverse disk is formed only on a front side of the of the hub section or is formed, for example, at a position, which essentially corresponds to the lengthwise bisector of the length of the hub section.

In the context of the present application, a monolithically formed hub section is particularly not to be understood as a hub section, which essentially consists of a pipe, into which a plurality of openings is subsequently introduced into the circumferential wall. On the contrary, the term of the monolithic formation is to relate to a hub section of this type, whereby based on a correspondingly selected production process, the shape of the hub section including the formation of the openings as well as the formation of at least one transverse disk is formed based on a single production process or production step, respectively.

The at least one transverse disk is preferably formed in a ring-shaped manner. The formation of a ring shape makes it possible that, for example, an inlet pipe of the solid bowl screw centrifuge can be guided through a transverse disk of this type. A ring shape can furthermore have the effect that liquid can flow through a centrally formed opening of the transverse disk. The ring-shaped transverse disk preferably has a circular ring width, which corresponds maximally to half the radius of the outer circle of the transverse disk.

In a further embodiment of the invention, it is possible that the transverse disk has at least one opening formed in the center of the transverse disk. This opening can be formed in a circular manner, for example. In addition, it is possible that the opening is formed elliptically or in a flower-shaped manner. The opening of the transverse disk preferably has such a shape that an inlet pipe of a solid bowl screw centrifuge can be guided through the opening.

In a further embodiment of the invention, it is possible that the transverse disk of at least one hub section has several openings formed on the outer circumference. The openings are thus formed in such a way in this case that the preferably circular outer circumferential edge is interrupted by several openings. The openings are preferably distributed evenly in the circumferential direction of the transverse disk. This provides, for example, for the passage of liquid. The introduction of further strutting or reinforcing bars is also conceivable in this case.

In a further embodiment of the invention, the at least one transverse disk can have several openings, which are arranged so as to be distributed in the circumferential direction. The openings are preferably distributed evenly in the circumferential direction of the transverse disk. In other words, the ring shape of a transverse disk, for example, can have several openings, which are arranged so as to be distributed evenly. Openings of this type provide for the passage of liquids. The openings, which are arranged so as to be distributed in the circumferential direction, can be formed, for example, in a circular or square or triangular manner. The actual shape of the openings can be selected as a function of the flow rates, which are to be attained. It is possible that the at least one transverse disk has several of the above-mentioned features and/or embodiments.

The transverse disk can have a variable thickness in its monolithic design due to a specifically selected production process. It is thus possible to form individual sections of the transverse disk with higher material thickness or larger thickness, respectively, so that the transverse disk forms reinforcing sections at these points. Such points with a higher thickness of the transverse disk can in particular be formed as a type of reinforcing strut. The thickness of the transverse disk can decrease, for example, from radially outwards to radially inwards. It is furthermore possible that the sections of the transverse disk, which have an increased thickness or material thickness, respectively, compared to the remaining sections of the transverse disk, are arranged like rays from an (imaginary) center of the transverse disk radially outwards.

The openings formed in the circumferential wall can be arranged in a spiral-like manner in the circumferential direction in such a way that, preferably between openings adjacent in the longitudinal direction, at least one web-like wall section is formed, which runs in a spiral-like manner in the circumferential direction and which forms at least a 120° rotation, in particular a 180° rotation or a 360° rotation over the entire length of the hub section. The at least one web-like wall section, which runs in a spiral-like manner in the circumferential direction, serves in particular as fastening surface for a screw flight, which is to be fastened to the screw hub. The formation of a web-like wall section, which runs in a spiral-like manner in the circumferential direction, has the advantage that the screw flight can easily be connected to the screw hub in an automated process, in particular in an automated welding process.

Due to the preferred embodiment of such a wall section, which runs in a spiral-like manner, which forms at least a 120° rotation, in particular a 180° rotation or a 360° rotation, several monolithically formed hub sections can be combined with one another in a simple manner and can be interconnected, so that a screw flight winds around the screw hub formed from several hub sections, preferably with constant slope.

The spiral-like arrangement of the openings in the circumferential wall is to preferably be understood in such a way that the openings as a whole form a spiral shape. This is possible, for example, due to different opening geometries and/or opening sizes and/or an arrangement of the openings, which is offset relative to one another in the longitudinal direction and/or circumferential direction of the hub section.

The spiral-like arrangement of the openings is preferably formed in such a way that the openings and/or the struts or strut-like elements, respectively, which limit the openings, are positioned in such a way that the opening or strut structure, respectively, is also formed continuously in response to a connecting of at least two hub sections.

In response to a connecting of several hub sections, the web-like wall section as well as the opening or strut structure, respectively, particularly preferably runs continuously or with the same slope, respectively. A screw hub formed in this way attains a particularly good clarifying effect.

In a further embodiment of the invention, the monolithically formed hub section has several webs, which limit the openings of the circumferential wall, wherein the webs, in particular the webs and the at least one web-like wall section, in each case extend in the longitudinal direction and transversely to the longitudinal direction of the screw hub. A spiral-like arrangement of the openings in the circumferential direction can be made possible in a structurally simple manner with the help of a web arrangement of this type.

In a further embodiment of the invention, such a number of openings is formed in the circumferential wall and/or the openings of the circumferential wall have such an opening cross section that the circumferential wall is formed as open wall structure.

In particular such a wall structure, which has a large number of openings and/or an overall high opening surface in the respective hub section, is to be understood as an open wall structure. In particular the sum of all individual opening surfaces of individual openings in the respective hub section is to be understood as opening surface. In other words, the opening surface does not have to be a continuous individual opening surface.

The value of the opening surface is preferably greater than the value of the closed surface. The portion of the wall structure, which is closed and which does not provide for a passage of material passage from the screw hub interior to the outside (or vice versa), is to be understood as closed surface. In particular, the sum of all individual closed surfaces in the circumferential wall of the hub section is to further preferably be understood as closed surface.

Furthermore and/or additionally, such a wall structure of the hub section, which has a large portion of openings in the circumferential direction, is to be understood as an open wall structure. The portion of openings is preferably higher than the portion of closed surfaces. The portion of openings in the circumferential direction of the screw hub is preferably at least 50 % further preferably at least 60%, particularly preferably at least 65 %, furthermore particularly preferably at least 80 % of the entire wall structure in the circumferential direction.

Particularly preferably, the described portion of openings in the circumferential direction is formed over the entire longitudinal extension of the open wall structure. In terms of the invention, an extension of a component, of a section, etc., which essentially runs in the direction of, preferably parallel to, the longitudinal axis of the screw hub and/or of the centrifugal screw, is to be understood as longitudinal extension.

In a particularly preferred embodiment of the invention, the cylindrical longitudinal section of the screw hub is formed completely with an open wall structure according to previous definitions.

The formation of an open wall structure contributes to the formation of a large pond depth in a solid bowl screw centrifuge.

In a particularly preferred embodiment of the invention, the at least one monolithically formed hub section is formed as cast body. In other words, the monolithically formed hub section is produced by means of a casting process. Standard casting materials can be used hereby. Extremely complicated constructions with respect to a hub section can generally be produced with the help of a casting process. Compared to production methods, which are based on a subsequent mill-out of openings or are based on welding together several rod elements or components, respectively, the manufacture of a hub section is simpler and more cost-efficient in a casting process.

When using a casting process, the at least one hub section is preferably made of a chromium-nickel steel and/or a duplex steel and/or a nickel-based steel.

In a particularly preferred embodiment of the invention, the at least one monolithically formed hub section can be produced by means of a lost wax process.

As part of a casting process, in particular of a lost wax process, it is possible to produce individual subsections of the at least one monolithically formed hub section in different cast grades. The cast grades, which are to be attained, of individual subsections can thus be selected as a function of the later component stress and/or acting material tensions.

It is additionally possible to produce or to form, respectively, individual subsections of the at least one monolithically formed hub section with different wall thicknesses as part of a casting process, in particular of a lost wax process. In other words, individual subsections of the at least one monolithically formed hub section can have different wall thicknesses. The wall thicknesses can be selected as a function of the later component stress and/or acting material tensions.

It is possible to form a plurality of hub sections with the help of a casting mold.

In a further embodiment of the invention, the at least one monolithically formed hub section can be produced by means of 3D printing processes. In the case of the production by means of 3D printing processes, the construction of complicated molds or superstructures, respectively, of a hub section is likewise made possible. Based on a 3D printing process, all sections and subregions of the hub section can be produced by means of a single production step, without post-processing operations, such as, for example, the subsequent introduction of openings by means of a milling process, being necessary.

When using a 3D printing process, the at least one hub section is preferably formed from a chromium-nickel steel and/or a duplex steel and/or a nickel-based steel.

A 3D printing process can take place, for example, by means of a shaping additive material application. The shaping additive material application can take place, for example, by means of a shielding gas welding device, wherein the shielding gas welding device is preferably operated with a welding gas, and this welding gas is selected from one of the subgroups of the main groups I, M1, M2 or N of the standard DIN EN ISO 14175.

A welding is preferably carried out with active, reactive welding gas or with inert welding gas. A welding process of this type can also be referred to as MAG or MIG welding, respectively, or as welding with active gas or inert gas, respectively. Welding processes of this type are collectively referred to as metal shielding gas welding process (MSG).

The main group I comprises welding gases with 100 percent by volume of argon in nominal terms (subgroup 1), 100 percent by volume of helium in nominal terms (subgroup 2) and 0.5 to 95 percent by volume of helium in nominal terms and the balance being argon (subgroup 3). These welding gases are completely inert.

The main group M1, subgroup 1 comprises welding gases with 0.5 to 5.0 percent by volume of carbon dioxide in nominal terms, 0.5 to 5.0 percent by volume of hydrogen in nominal terms and the remainer being argon or helium. These welding gases are mildly oxidizing and only mildly reducing. The main group M1, subgroup 2 comprises welding gases with 0.5 to 5.0 percent by volume of carbon dioxide in nominal terms and the balance being argon or helium. These welding gases are mildly oxidizing. The main group M1, subgroup 3 comprises welding gases with 0.5 to 3.0 percent by volume of oxygen in nominal terms and the balance being argon or helium. These welding gases are likewise mildly oxidizing. The main group M1, subgroup 4 comprises welding gasses with 0.5 to 5.0 percent by volume of carbon dioxide in nominal terms, 0.5 to 3.0 percent by volume of oxygen in nominal terms and the balance being argon or helium. These welding gases, in turn, are mildly oxidizing.

The main group M2, subgroup 0 comprises welding gases with 5.0 to 15.0 percent by volume of carbon dioxide in nominal terms and the balance being argon or helium. These welding gases are mildly oxidizing. The main group M2, subgroup 1 comprises welding gases with 15.0 to 25.0 percent by volume of carbon dioxide in nominal terms and the balance being argon or helium. These welding gases are likewise mildly oxidizing. The main group M2, subgroup 2 comprises welding gasses with 3.0 to 10.0 percent by volume of oxygen in nominal terms and the balance being argon or helium. These welding gases are likewise still mildly oxidizing. The main group M2, subgroup 3 comprises welding gases with 0.5 to 5.0 percent by volume of carbon dioxide in nominal terms, 3.0 to 10.0 percent by volume of oxygen in nominal terms and the balance being argon or helium. The main group M2, subgroup 4 comprises welding gases with 5.0 to 15.0 percent by volume of carbon dioxide in nominal terms, 0.5 to 3.0 percent by volume of oxygen in nominal terms and the balance being argon or helium. The main group M2, subgroup 5 comprises welding gasses with 5.0 to 15.0 percent by volume of carbon dioxide in nominal terms, 3.0 to 10.0 percent by volume of oxygen in nominal terms and the balance being argon or helium. The main group M2, subgroup 6 comprises welding gases with 15.0 to 25.0 percent by volume of carbon dioxide in nominal terms, 0.5 to 3.0 percent by volume of oxygen in nominal terms and the balance being argon or helium. The main group M2, subgroup 7 comprises welding gases with 15.0 to 25.0 percent by volume of carbon dioxide in nominal terms, 3.0 to 10.0 percent by volume of oxygen in nominal terms and the balance being argon or helium. These welding gases are also still comparatively mildly oxidizing.

The main group N, subgroup 1 comprises welding gases with 100 percent by volume of nitrogen in nominal terms. The main group N, subgroup 2 comprises welding gases with 0.5 to 5.0 percent by volume of nitrogen in nominal terms and the balance being argon or helium. The main group N, subgroup 3 comprises welding gases with 5.0 to 50.0 percent by volume of nitrogen in nominal terms and the balance being argon or helium. The main group N, subgroup 4 comprises welding gases with 0.5 to 1.0 percent by volume of hydrogen in nominal terms, 0.5 to 5.0 percent by volume of nitrogen in nominal terms and the balance being argon or helium. The main group N, subgroup 5 comprises welding gases with 0.5 to 50.0 percent by volume of hydrogen in nominal terms and the balance being nitrogen. All of these welding gasses are inert. They are inert with high argon or helium content and they are only mildly reducing even with increasing hydrogen content.

In summary, welding gases, which are inert, mildly oxidizing and/or mildly reducing, are thus preferably selected systematically. In the case of the shaping build-up welding or the shaping additive material application, respectively, it is thus possible to work with a low-oxidation weld bead and largely without slag by means of such a method. This is particularly advantageous in particular for placing weld beads one on top of the other. It is furthermore possible to work at a particularly quick welding speed. This initially provides for particularly short production times. However, the actual advantage of quick welding speed lies in that the at least one monolithically formed hub section is heated up selectively only little and only little warping or deformation thus results, respectively.

A large advantage of the described approach lies in the fact that a particularly high wear resistance of the surface produced thereby results in the case of such a build-up welding.

According to this exemplary embodiment, a subsequent tempering, for example, in particular an application of wear layers, can thus be forgone.

For example, the welding gas has a portion of carbon dioxide of less than twenty percent by volume in nominal terms. Such a low carbon dioxide content makes it possible in particular that structural steels can be processed by means of impulse welding. A comparatively high combustion of the welding wire is possible at the same time. This results in a high mass build-up during the welding and a particularly fast operation. Welding gas, which has a portion of oxygen of less than three percent by volume in normal terms, is preferably used as welding gas. Such welding gases are particularly mildly oxidizing. Welding gases, which have a high portion of argon, are further particularly cost-efficient.

In one embodiment of the invention, a shielding gas welding device is operated with a pulsed arc. Such a pulsed arc allows for a precise control of the smelting of the welding wire at the shielding gas welding device. The heat input into the at least one monolithically formed hub section can furthermore systematically be kept particularly low. Temperature-related deformations can thus be kept low. The electrical welding current of the pulsed arc welding device of this type has, for example, a base current of less than 200 amperes and a pulse current of greater than 200 amperes. Such welding currents are advantageous in the case of particularly precise material build-up with comparatively low heat introduction. A welding gas with 98 percent by volume of argon in nominal terms and 2 percent by volume of carbon dioxide in nominal terms is preferably used as welding gas thereby.

It is further of particular advantage to operate a shielding gas welding device with a short arc, in particular an energy-reducing short arc. Such a method with short arc is also referred to as cold arc, thus a method with particularly cold arc. An intensified melting current pulse is particularly advantageously used for attaining an arc, which nonetheless has a high melt strength.

A shielding gas welding device is particularly advantageously operated with a welding wire, or advantageously also two welding wires (twin welding process) with a diameter of 0.5 mm to 3.0 mm, preferably of 1.0 mm to 1.6 mm.

Such a welding wire diameter provides for a high welding speed and simultaneously for a particularly low thermally induced deformation. Individual welding layers or welding plies, respectively, with a width of 6 to 7 mm are particularly preferred. Provided that a contour is to be produced by means of the method according to the invention, a welding layer or a welding ply, respectively, has a width of at least 2 mm.

The at least one hub section, which is to be formed monolithically, can preferably be moved during the production. By means of the movement, the at least one hub section, which is to be formed monolithically, is thereby aligned on its welding point in such a way that an optimal position results for the applied welding plie. The welding plie is thereby particularly preferably applied to a horizontal surface.

It is also advantageous when the welding plie is applied onto a surface, which slopes slightly in the welding direction. The angle of inclination is preferably between 5° and 15°, advantageously between 7° and 10°. The at least one hub section, which is to be formed monolithically, is accordingly preferably moved in such a way that a horizontal welding surface or a welding surface, which rises in the welding direction of the shielding gas welding device, is present at the welding location of the shielding gas welding device.

The screw hub can have several, in particular two or three or four or five, hub sections, which are interconnected. The connected hub sections form a longitudinal section of the screw hub, preferably the complete longitudinal section of the screw hub. The cylindrical longitudinal section of a screw hub can thus be formed from several, preferably similar or identical hub sections. This provides for a simple modular assembling or joining, respectively, of the screw hub of an optional number of several hub sections.

The hub sections can in particular be interconnected by means of a substance-to-substance bond and/or in a non-positive manner. With respect to a substance-to-substance bond, a welded connection is suitable in a special way. On the one hand, this provides for a stable connection of the hub sections. On the other hand, this is a comparatively simple method for connecting the hub sections, wherein a corresponding welding process can also be carried out in an automated manner. In the case of the non-positive connection of the hub sections, in particular by means of screwing, a hub section can be released easily and quickly and can thus be replaced, for example due to wear. A modular design of the screw hub is further made possible by means of such a connection of the hub sections, so that the screw hub can be produced easily in different installation sizes or installation lengths, respectively.

The hub sections are preferably interconnected in such a way that web-like wall sections of the respective hub sections, in particular web-like wall sections according to subclaim 6, are positioned relative to one another in such a way that a continuously spirally running fastening section for fastening a screw flight is formed over the complete longitudinal section of the screw hub. This provides for the secure and automated fastening of a screw flight to the screw hub. In a further embodiment of the invention, several web-like wall sections can be formed in the circumferential wall. This provides for the formation of several fastening sections for fastening several screw flights.

With the help of a screw hub formed according to the invention, it is made possible in an advantageous manner to replace or to repair, respective, individual hub sections of screw hubs, provided that they are defective or have traces of wear. This also relates to hub sections of screw hubs, which are or were initially not formed according to the invention, respectively, wherein the screw hub has a hub section of a screw hub according to the invention after repairs have been made.

A further secondary aspect of the invention relates to a centrifugal screw with a screw hub according to the invention and a screw flight, which is circumferentially arranged on the screw hub.

The screw flight is preferably fastened to spirally running fastening sections of the screw hub. The at least one spirally running fastening section is preferably formed by means of a web-like wall section of the circumferential wall. It is possible that the centrifugal screw has several screw flights, in particular two screw flights. In this case, at least two web-like wall sections, which are arranged spaced apart from one another, are formed in the circumferential wall of the at least one hub section, preferably of the several hub sections, in order to provide for a fastening of the two screw flights.

A further secondary aspect of the invention relates to a solid bowl screw centrifuge, which comprises a centrifugal screw located in a drum, wherein the centrifugal screw is formed according to the invention and/or has a screw hub according to the invention.

With respect to the centrifugal screw as well as with respect to the solid bowl screw centrifuge, reference is made to the advantages described in connection with the screw hub.

The invention will be described in more detail below with further details with reference to the enclosed drawings.

The illustrated embodiments represent examples for how the screw hub according to the invention or the centrifugal screw according to the invention, respectively, can be formed. Monolithically formed hub sections, which can form a screw hub according to the invention, are in particular illustrated in the figures.

In the figures:

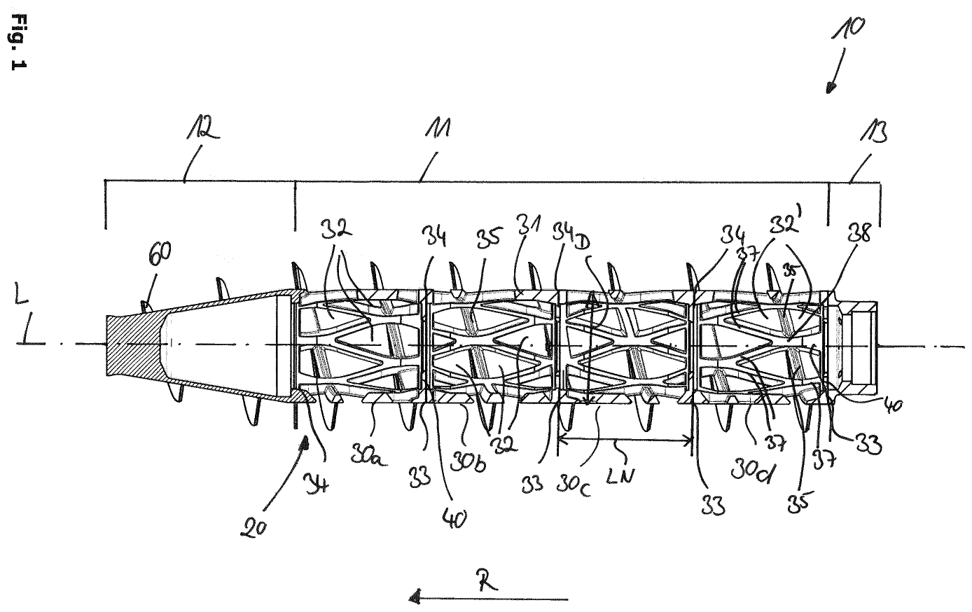

FIG. 1 shows a longitudinal section through a centrifugal screw according to the invention;

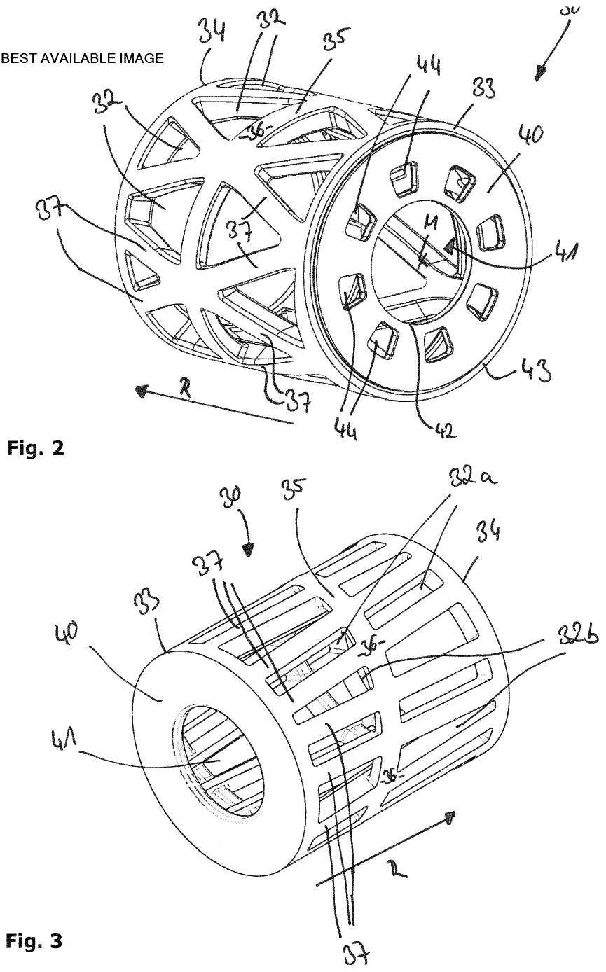

FIG. 2-4 show different embodiments with respect to a monolithically formed hub section for forming a screw hub according to the invention.

The same reference numerals will be used below for identical parts and for identically acting parts.

A centrifugal screw 10 according to the invention with a screw hub 20 according to the invention is illustrated in FIG. 1. In the longitudinal direction R, the screw hub 20 has a cylindrical longitudinal section 11, a conical section 12 as well as a bearing section 13. The sections 11, 12 and 13 have the longitudinal axis L as common axis.

In the present case, the conical section 12 corresponds to the solid material-side section, provided that the illustrated centrifugal screw is formed as part of a solid bowl screw centrifuge.

The bearing section 13 serves the purpose of receiving a bearing, in particular a screw bearing, in order to rotatably mount the screw hub 20.

It is possible that in further embodiments of the invention, the section 12 has a shape, which deviates from the simple conical shape. For example, the section 12 can be formed as cylinder section and cylindrical pipe section. It is furthermore possible that the section 12 has the shape of a double truncated cone. The cylindrical longitudinal section 11 of the screw hub 20 is arranged in the longitudinal direction R between the conical section 12 and the bearing section 13. The sections 11, 12 and 13 are firmly interconnected.

The screw hub 20 is surrounded radially on the outside by the screw flight 60. The screw hub 20 thus serves the purpose of supporting the screw flight 60 in the radial direction, of transferring torques from the drive to the screw flight 60 and to in particular absorb tractive forces and shearing forces thereby.

The longitudinal direction R essentially runs parallel to the longitudinal axis L of the screw hub 20. In the present case, the longitudinal direction R is defined as the direction of the transport of the solid material discharge. According to the illustration of FIG. 1, the solid material transport takes place from right to left.

The cylindrical longitudinal section 11 is formed to be longer than the conical section or solid material discharge-side section 12, respectively. The section 12 of the screw hub 20 is to be understood as such a section, which in particular serves the purpose of transporting the solid material separated from the material to be processed in the direction R of the solid material discharge.

In the illustrated example, the cylindrical longitudinal section 11 of the screw hub 20 is formed from four hub sections 30a, 30b, 30c and 30d. The monolithically formed hub sections 30a, 30b, 30c and 30d are interconnected, in particular welded together. The two hub sections 30b and 30c can be referred to as central hub sections. They are located between the end-side hub sections 30a and 30d. The end-side hub section 30a thus forms the end part pointing to the conical section 12 or the end section of the cylindrical longitudinal section 11, respectively. The end-side hub section 30d, in contrast, forms the end part or end section, respectively, of the cylindrical longitudinal section 11, which points to the bearing section 13 or to the end of the screw hub 20, respectively, which lies opposite in relation to the conical section 12.

The hub sections 30a-30d in each case have a circumferential wall 31, in which a plurality of openings 32 is formed. Each hub section 30a-30d in each case furthermore has a transverse disk 40. The transverse disk 40 is in each case formed on a front side, namely on the second front side 34 of the respective hub section 30a-30d. The individual hub section 30a-30d in each case has two front side, namely a first front side 33 and a second front side 34. The front sides 33 and 34 limit the longitudinal extension of the circumferential wall in the longitudinal direction R. The first front side 33 is the first front side of the respective hub section 30a-30d in each case in the longitudinal direction R. The second front side 34 forms the second front side of the respective hub section 30a-30d, which is formed in the longitudinal direction R. The hub sections 30a-30d are interconnected in such a way that the second front side 34 of a hub section is in each case connected to the first front side 33 of the hub section 30a 30d of the adjacent or abutting hub section, respectively. The transverse disk 40 is thus in each case located in the connecting region between two hub sections.

The length LN of the respective hub section 30a-30d is preferably 1- to 2-times the diameter D of the hub section 30a-30d. In the present case, all of the hub sections 30a 30d are formed identically. This also relates to the length LN of the hub section as well as of the corresponding ratio to the respective diameter D of the hub section. It can be seen in the illustrated longitudinal section of the screw hub 20 that at least one web-like wall section 35, which runs spirally, is formed in the circumferential wall 31. This web-like wall section 35 forms a bearing surface for the screw flight 60 on the surface 36, which points outwards. The screw flight 60 can be connected to the screw hub 20 at this bearing surface.

The web-like wall section 35 runs over the entire length LN of the hub section 30 in such a way that at least a 120° rotation is formed. In the illustrated example, a rotation of more than 360° is formed. Due to the fact that the hub sections 30a-30d are formed identically, the hub sections 30a-30d can be positioned relative to one another and can be fastened to one another in such a way that the individual web-like wall sections 35 form a web-like wall section, which runs continuously with respect to the cylindrical longitudinal section 11 of the screw hub 20. This continuously running web-like wall section of the cylindrical longitudinal section 11 preferably has a consistent slope over the entire length of the cylindrical longitudinal section 11.

In the present case, the openings 32 of the hub sections 30a-30d in each case have a triangular shape. Using the example of the end-side hub section 30d, it becomes clear that this triangular shape is in each case formed by two struts or strut-like elements 37, respectively, and a subsection of the web-like wall section 35. The two openings 32′ are positioned relative to one another in such a way that, together, they form a rhombus shape. Several rhombuses, in turn, are arranged so as to be offset from one another in the hub section 30d. In this exemplary embodiment, the web-like wall section 35 (which serves the purpose of fastening a screw flight) runs through the junctions 38 of the struts 37. Such a formation of the hub section 30d provides for a particularly stable and simultaneously light construction of the hub section 30d. In the illustrated example, all hub sections 30a-30d have the same basic construction.

An individual monolithically formed hub section 30 is illustrated in FIG. 2, which can form a cylindrical longitudinal section 11 of the screw hub 20 according to FIG. 1. The perspective view in particular shows the formation of the transverse disk 40. The transverse disk 40 is essentially formed in a ring-shaped manner.

The ring surface is formed between an inner circle edge 42 and an outer circle edge 43.

The opening 41 is formed in the center M of the transverse disk 40. The diameter of the opening 41 is formed by means of the inner circle edge 42.

The circular ring width KB is preferably maximally 50% of the radius r of the transverse disk 40.

On the one hand, the opening 41 of the transverse disk 40 serves the purpose of the guide-through of an inlet pipe. This is necessary in particular when forming the hub section 30, provided that this is arranged, for example, at the positions of the screw hub 20, in order to form a hub section 30c or 30d (see FIG. 1). The opening 41 furthermore serves the purpose of allowing liquid to pass.

Additional openings 44 are formed in the circular ring of the transverse disk. These openings are arranged so as to be distributed evenly in the radial direction of the transverse disk 40. These openings 44 also for the purpose of allowing liquids to pass.

It has been shown that a circular ring width KB with the specified maximum size effects a sufficient stability on the one hand and forms a largest possible passage for liquids, on the other hand.

The circumferential wall 31 of the hub section 30 is formed with an open wall structure. This means that in the present case, the circumferential wall 31 has such a number of openings 32 as well as such an opening cross section of the openings 32 that the circumferential wall 31 as a whole can be referred to as an open wall structure. In the present case, the openings 32 essentially have a triangular shape. The triangular shapes of the openings 32 are offset and are arranged alternately to one another in such a way that a web-like wall section 35, which runs in a spiral-like manner in the circumferential direction, is formed between the openings 32.

The surface 36 of the web-like wall section 35, which points outwards, can be seen. A screw flight 60 (not illustrated) can be fastened to this surface 36, which points outwards. To form the opening cross sections, which are triangular in this case, the openings 32 are formed by means of struts 37 and subsections of the web-like wall section 35, wherein the struts 37 and the web-like wall section 35 in each case extend in the longitudinal direction R and transversely to the longitudinal direction R of the screw hub 20. Such a shape of a hub section 30 can in particular be produced by means of a casting process, whereby the openings 32 are arranged offset from one another and so as to alternate with respect to the shape.

An alternative embodiment with respect to a hub section 30 is illustrated in FIG. 3. This hub section 30 also has a transverse disk 40 on a front side, wherein this transverse disk 40 likewise has a circular ring shape.

The hub section 30 differs from the hub section 30 according to the embodiment of FIG. 2 in particular by the shape of the openings 32 formed in the circumferential wall 31. With respect to the size and shape, the openings 32 are formed in such a way that a spirally running web-like wall section 35 with a surface 36 pointing outwards is formed, in turn. To form the spirally running web-like wall section 35, the openings 32 have different longitudinal extensions in the longitudinal direction R. The shapes of the openings 32 furthermore differ from one another. The openings 32a essentially have a square basic structure. The openings 32b, in contrast, have a triangular shape. The sections of the circumferential wall 31 formed between the front sides 33 and 34 as well as the web-like wall section 35 are thus formed with largest possible openings 32, wherein a spiral course of the web-like wall section 35 is made possible at the same time.

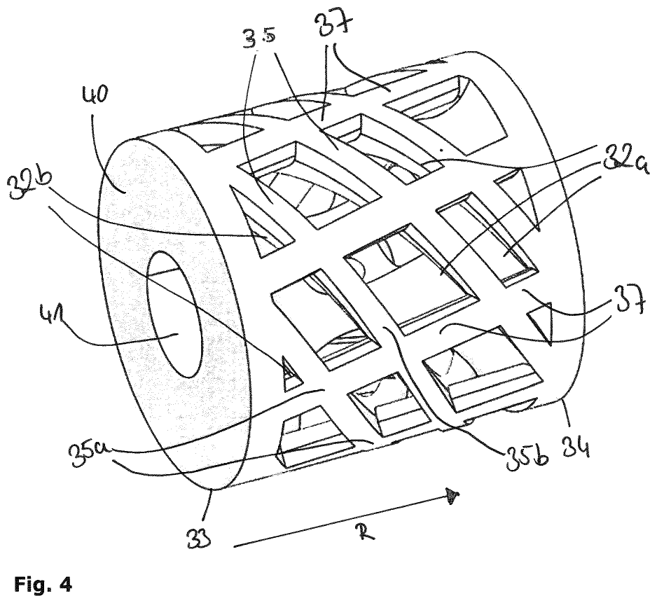

A further embodiment with respect to a hub section 30 is illustrated in FIG. 4. On a front side 33, it has a transverse disk 40, in turn. As already described in connection with the embodiment according to FIG. 3, the openings 32 have different opening shapes.

In addition to triangular openings 32, essentially square openings 32a are formed.

The hub section 30 has two web-like wall sections 35a and 35b. The web-like wall sections 35a and 35b run spirally and spaced apart from one another. Due to the formation of two web-like wall sections 35a and 35b, several screw flights 60, which are spaced apart from one another, can be fastened to a screw hub. The web-like wall sections 35a and 35b both run over the entire length LN of the hub section 30 and in each case form an at least 120° rotation.

By connecting several hub sections 30, as it is illustrated in FIG. 3, a screw hub 20, in particular a cylindrical longitudinal section 11 of a screw hub 20, can be formed, which has several, in particular two screw flights.

Due to the large number and size of formed openings 32a and 32b, an open wall structure is formed, in turn. The openings 32a and 32b are formed by struts 37 and subsections of the web-like wall sections 35a and 35b.

Finally, it is important to mention that in spite of the formal reference to one or several certain claims, all features, which are mentioned in the application documents and in particular in the dependent claims, are to be given independent protection, also individually or in any combination.

### LIST OF REFERENCE NUMERALS

10 centrifugal screw
11 cylindrical longitudinal section
12 conical section
13 bearing section
20 screw hub
30, 30a, 30b, 30c, 30d hub section
31 circumferential wall
32, 32′, 32a, 32b opening circumferential wall
33 first front side
34 second front side
35, 35a, 35b web-like wall section
36 surface pointing outwards
37 strut
38 junction
40 transverse disk
41 opening transverse disk
42 inner circle edge
43 outer circle edge
44 openings arranged SO as to be distributed
60 screw flight longitudinal axis
LN length hub section
D diameter hub section
R longitudinal direction
r radius transverse disk
M center transverse disk
KB circular ring width

1. A screw hub (20) for a centrifugal screw (10), comprising at least one monolithically formed hub section (30), in particular at least two interconnected monolithically formed hub sections (30),
wherein the at least one hub section (30) has a circumferential wall (31) and two front sides (33, 34) and a plurality of openings (32) is formed in the circumferential wall (31),
wherein the hub section (30) has at least one transverse disk (40).

2. The screw hub (20) according to claim 1,
characterized in that
the length (LN) of the hub section (30) is 0.5- to 3-times, in particular 0.75 to 2.5-times, in particular 1- to 2-times, the diameter (D) of the hub section (30).

3. The screw hub (20) according to claim 1,
characterized in that
the at least one transverse disk (40) is formed on a front side (33, 34) of the hub section (30).

4. The screw hub (20) according to claim 1,
characterized in that
the at least one transverse disk (40) is formed in the longitudinal direction (R) of the hub section (30) at a position, which essentially corresponds to the lengthwise bisector of the length (LN) of the hub section (30).

5. The screw hub (20) according to claim 1,
characterized in that
the at least one transverse disk (40) is formed in a ring-shaped manner and/or has at least one opening (41) formed in the center (M) of the transverse disk (40) and/or several openings formed on the outer circumference and/or several openings arranged so as to be distributed in the circumferential direction.

6. The screw hub (20) according to claim 1,
characterized in that
in the circumferential wall (32), at least one web-like wall section (35) is formed, which runs in a spiral-like manner in the circumferential direction and which forms at least a 120° rotation, in particular a 180° rotation or a 360° rotation over the entire length (LN) of the hub section.

7. The screw hub (20) according to claim 6,
characterized in that
the openings (32) formed in the circumferential wall (31) are arranged in a spiral-like manner in the circumferential direction in such a way that, preferably between openings (32) adjacent in the longitudinal direction (R), at least one web-like wall section (35) is formed, which runs in a spiral-like manner in the circumferential direction and which forms at least a 120° rotation, in particular a 180° rotation or a 360° rotation over the entire length (LN) of the hub section (30).

8. The screw hub (20) according to claim 1,
characterized by
several webs (37), which limit the openings (32) of the circumferential wall (31), wherein the webs (37), in particular the webs (37) and the at least one web-like wall section (35), in each case extend in the longitudinal direction (R) and transversely to the longitudinal direction of the screw hub (20).

9. The screw hub (20) according to claim 1,
characterized in that
such a number of openings (32) is formed in the circumferential wall (31) and/or the openings (32) of the circumferential wall (31) have such an opening cross section that the circumferential wall (31) is formed as open wall structure.

10. The screw hub (20) according to claim 1,
characterized in that
the at least one hub section (30) is formed as cast body.

11. The screw hub (20) according to claim 1,
characterized in that
the at least one hub section (30) is produced by means of 3D printing methods.

12. The screw hub (20) according to claim 1,
characterized by
several, in particular two or three or four or five, hub sections (30), which are interconnected, in particular interconnected by means of a substance-to-substance bond and/or in a non-positive manner, and form at least one longitudinal section (11) of the screw hub (20), preferably the complete longitudinal section (11) of the screw hub (20).

13. The screw hub (20) according to claim 12,
characterized in that
the hub sections (30) are interconnected in such a way that web-like wall sections (35) of the hub sections (30) are positioned relative to one another in such a way that a continuously spirally running fastening section for fastening a screw flight (60) is formed over the complete longitudinal section (11) of the screw hub (20).

14. A centrifugal screw (10) with a screw hub (20) according to claim 1 and at least one screw flight (60), which is circumferentially arranged on the screw hub (20).

15. A solid bowl screw centrifuge with a centrifugal screw (10) according to claim 14 and/or a screw hub (20).
